(19) United States
(12) Patent Application Publication
(10) Pub. No.: US 2026/0187357 A1
(43) Pub. Date: Jul. 2, 2026

(54) METHOD FOR DOCUMENT PROCESSING OF TABLES CONTAINED IN A FILE IN PDF FORMAT

(71) Applicant: JACKSOFT COMMERCE AUTOMATION LTD., Chiayi City (TW)

(72) Inventor: Hsiu-Feng HUANG, Chiayi City (TW)

(73) Assignee: JACKSOFT COMMERCE AUTOMATION LTD., Chiayi City (TW)

(21) Appl. No.: 19/431,930

(22) Filed: Dec. 23, 2025

(30) Foreign Application Priority Data
Dec. 30, 2024 (TW) 113151494

(51) Int. Cl. G06F 40/177; G06F 40/109; G06V 30/413

(52) U.S. Cl. CPC G06F 40/177; G06F 40/109; G06V 30/413

(57) ABSTRACT

A method for document processing of tables contained in a PDF file includes: obtaining tables contained in the PDF file and assigning table numbers respectively to the tables; categorizing each one of the tables into one of a headed table and a headerless table; generating a set of headers for each headerless table to make the headerless table become one of the headed tables; after generating the set of headers for each headerless table to make the headerless table become one of the headed tables, for each headed table, identifying a data type for data in each column in the headed table to obtain a data type identification result; grouping the headed tables to obtain at least one table group; for each table group, merging the tables in the table group sequentially based on the table numbers respectively of the tables in the table group to obtain a merged table.

### CROSS-REFERENCE TO RELATED APPLICATION

This application claims priority to Taiwanese Invention Patent Application No. 113151494, filed on December 30, 2024, the entire disclosure of which is incorporated by reference herein.

### FIELD

The disclosure relates to a document processing method, and more particularly to a method for document processing of tables contained in a file in Portable Document Format (PDF).

### BACKGROUND

Nowadays, files received from organizations and businesses, such as various bills (e.g., phone bills, utility bills, bank statements, etc.), financial reports, purchase orders, and various contracts, are mostly in Portable Document Format (PDF). When analyzing data in a PDF file, extracting data contained in tables is particularly difficult. Although there are some tools that can export tables in a PDF file into Excel or Comma-Separated Values (CSV) files, most of these tools extract tables on different pages of the same PDF file as separate data tables. Data analyzing personnel often need to merge the data tables before performing data analysis. If there are a large number of pages with tables in a PDF file, this process will undoubtedly cause challenges for data analyzing personnel. Furthermore, the same PDF file may contain tables without column titles, a single table spanning multiple pages, or multiple tables with different column names. The diversity of tables in a PDF file also makes it more difficult for data analyzing personnel to merge data tables.

### SUMMARY

Therefore, an object of the disclosure is to provide a method for document processing of tables contained in a file in Portable Document Format (PDF) that can alleviate at least one of the drawbacks of the prior art.

According to the disclosure, the method includes steps of: obtaining tables contained in the file and assigning table numbers respectively to the tables; for each one of the tables, categorizing the table into one of a type of table with headers and a type of table without headers, wherein each one of the tables having a set of headers is categorized into the type of table with headers; for each one of the tables that is categorized into the type of table without headers, generating a set of headers for the table that is categorized into the type of table without headers so as to make the table become the type of table with headers; after the step of generating a set of headers for the table that is categorized into the type of table without headers, for each one of the tables, identifying a data type for data in each column in the table, so as to obtain a data type identification result corresponding to the table; based on the set of headers of each one of the tables, a number of columns of each one of the tables, and the data type identification results respectively of the tables, grouping the tables to obtain at least one table group, each one of the at least one table group including at least one of the tables all having the same set of headers, the same number of columns and the same data type identification result; and for each one of the at least one table group, merging the tables in the table group sequentially based on the table numbers respectively of the tables in the table group, so as to obtain a merged table.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart of a method for document processing of tables contained in a file in Portable Document Format (PDF) according to an embodiment of the disclosure.

FIG. 2 is a block diagram illustrating a computing device used for implementing the method according to an embodiment of the disclosure.

FIG. 3 is a flow chart illustrating how a processor of the computing device generates a set of headers for a table that is categorized into a type of table without headers.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

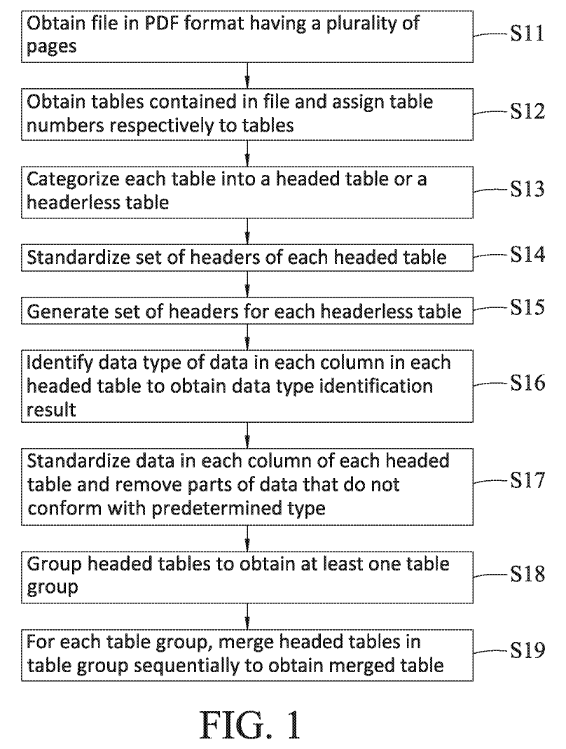

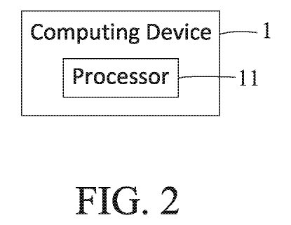

Referring to FIGS. 1 and 2, a method for document processing of tables contained in a file in Portable Document Format (PDF) according to an embodiment of the disclosure is implemented by a computing device 1. The computing device 1 includes a processor 11. The processor 11 may be embodied using, for example, one or more of a central processing unit (CPU), a graphic processing unit (GPU), a microprocessor, a microcontroller, a single core processor, a multi-core processor, a dual-core mobile processor, a digital signal processor (DSP), a field-programmable gate array (FPGA), an application-specific integrated circuit (ASIC), a radio-frequency integrated circuit (RFIC), etc. The method includes the following steps.

In step S11, the processor 11 obtains a file in PDF format having a plurality of pages.

In step S12, the processor 11 obtains tables contained in the file, and assigns table numbers respectively to the tables thus obtained. Each one of the tables may contain at least one column and at least one cell. It should be noted that each page of the file may contain one or more tables, or may not contain any table.

Specifically, for each page of the plurality of pages, the processor 11 analyzes the page to obtain a text analysis result that relates to text content, text spacing and text alignment on the page, and to obtain a line analysis result that relates to visible lines on the page. Based on the text analysis result and the line analysis result, the processor 11 obtains, if any, at least one table contained in the page and assigns at least one table number respectively to the at least one table.

In more detail, for each table, the processor 11 automatically determines table boundaries of the table based on horizontal and vertical spacing between text on the page as indicated by the text analysis result. For example, the processor 11 may analyze the horizontal and vertical spacing between groups of text adjacent to each other in an area of the page. When it is determined that the horizontal and vertical spacing between the groups of text is consistent and the groups of text form a rectangular arrangement, it is determined that the area may contain a table boundary. The processor 11 also automatically determines each cell of the table based on the text alignment and the text spacing on the page. For example, the processor 11 may use a text clustering algorithm (e.g., K-means) to partition groups of text into clusters based on position density of the text, so that each group of text that has a higher density of text and that is arranged in a grid pattern is identified as a cell of the table. The processor 11 delineates rows and columns of the table based on the visible lines indicated by the line analysis result and by performing, e.g., a grid pattern consistency check to analyze alignment of the rows and the columns. For example, when multiple lines of text are relatively highly aligned on the left or right, it may be determined that the lines of text belong to the same column.

Furthermore, the processer 11 automatically corrects discontinuous grid lines in the table by comparing the rows and the columns thus delineated with a table structure determined by the text analysis result. If the line analysis result indicates a presence of partially visible boundary lines, the processor 11 may use, e.g., boundary expansion to calculate positions of missing parts of the boundary lines based on text arrangement and line segment positions of the boundary lines, so as to complete the table boundaries. If the text analysis result indicates that the alignment of certain rows or columns is consistent, but the line analysis result indicates the presence of partially visible boundary lines, the processor 11 may use text-driven line inference to automatically fill in the missing parts of the boundary lines. If it is determined that there is directional continuity between a short line segment and another line, the processor 11 may calculate a direction and a length of extension, and extend the short line segment based on the direction and the length so as to complete the lines. If it is determined that there is a small gap between two line segments, the processing unit 11 may fill in the gap by reconstructing the missing line segment based on an average thickness, positions and angles of the line segments on both side of the gap. Based on the grid lines of the table, if it is determined that there is a difference in position between the table on the page and the table structure determined by the text analysis result, the processor 11 automatically draws or adjusts the grid lines so that the table may be presented as a consistent and complete rectangular grid. It should be noted that the processor 11 may also calculate a confidence score before performing a correction to the table boundary, and may only perform the correction if the confidence score exceeds a preset threshold value that may be set based on practical needs. Through the above procedures, the processing unit 11 automatically determines the table boundaries.

It is worth mentioning that when analyzing the page to obtain the tables, the processor 11 may use the narrowest column as a basis for identifying lines of each column (e.g., by first dividing each of the tables into columns according to the narrowest column, then determining whether there are wide columns or merged columns), so as to more accurately determine the columns. Furthermore, the processor 11 may use the smallest cell to identify lines of each row, so as to more accurately identify cells that span two or more columns, which cannot be presented with a fixed column width.

The processor 11 may assign the table number to each table based on a number manually inputted by an operator of the computing device 1, or by executing a pre-stored program on the computing device 1 that enables the processor 11 to automatically assign a number each time a table is obtained, but the disclosure is not limited thereto. It should be noted that the table numbers assigned respectively to the tables contained in the file are in ascending order; that is, a table on an earlier page is assigned with a smaller table number than a table on a later page, and on the same page, a previous table is assigned with a smaller table number than the following table. In some embodiments, the table numbers may be in descending order.

In step S13, for each one of the tables, the processor 11 categorizes the table into a type of table with headers (hereinafter referred to as a “headed table”) or a type of table without headers (hereinafter referred to as a “headerless table”). Each one of the tables that has a set of headers is categorized as a headed table. Each one of the tables that does not have a set of headers is categorized as a headerless table.

More specifically, for each one of the tables, the processor 11 identifies a header area and a data area based on format characteristics of each cell of the table, so as to categorize the table as a headed table or a headerless table. In a case where the header area and the data area are identified for the table, the table is categorized as a headed table. In a case where the data area is identified, but the header area is not identified for the table, the table is categorized as a headerless table. The processor 11 also marks the starting row number of the data area of the table. For example, the starting row number of the data area of one of the headed tables may be “row 2”; the starting row number of the data area of one of the headerless tables may be “row 1”. In the present embodiment, the format characteristics include at least a font size, a font style, a typeface style and a data type (e.g., text only, numeric value, date, currency symbol, etc.). For example, the processor 11 may identify as the header area cells that have the font size of “14”, the font style of “bold”, the typeface style of “Arial”, and the data type of “text only”. The processor 11 may identify as the data area cells that have the font size of “10”, the font style of “none”, the typeface style of “Arial”, and the data type of “text only”.

In step S14, for each headed table, the processor 11 standardizes the set of headers of the headed table by using, for example, string matching, space removal and case unification.

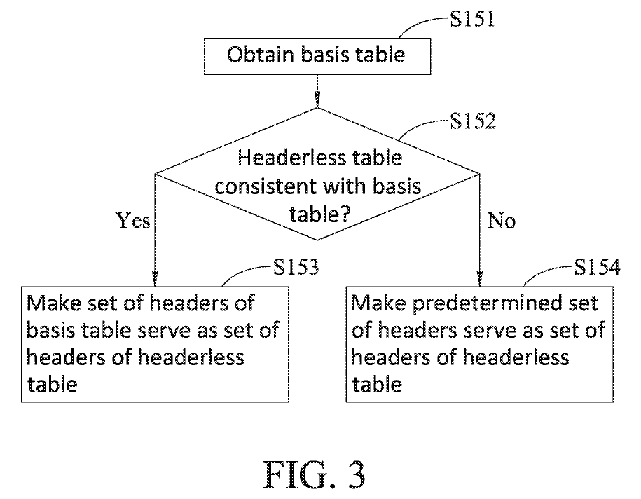

In step S15, for each headerless table, the processor 11 generates a set of headers for the headerless table so as to make the headerless table become a headed table. That is, all of the tables are headed tables at this time. Referring to FIG. 3, more specifically, step S15 includes the following sub-steps.

In sub-step S151, the processor 11 obtains a basis table. The basis table is one of the headed tables and has the table number that is sequentially before and closest to the table number of the headerless table. For example, in a case where the table number of the headerless table is 2, the basis table may be one of the headed tables that has the table number of 1.

In sub-step S152, the processor 11 determines whether the headerless table is consistent with the basis table based on a number of columns of the basis table, format characteristics of a data area of the basis table, a number of columns of the headerless table, and format characteristics of a data area of the headerless table. In response to determining that the headerless table is consistent with the basis table, sub-step S153 is performed. In response to determining that the headerless table is not consistent with the basis table, sub-step S154 is performed.

In sub-step S153, the processor 11 makes the set of headers of the basis table serve as the set of headers of the headerless table.

In sub-step S154, the processor 11 makes a predetermined set of headers serve as the set of headers of the headerless table. The predetermined set of headers may be set by the operator of the computing device 1 in advance based on the type of the file, or may be preprogrammed into the computing device 1. For example, in a case where the file is a credit card statement, the predetermined set of headers may include “date of transaction“, “merchant”, “transaction amount”, etc.

In step S16, after step S15 is performed, for each headed table, the processor 11 identifies the data type (e.g., text only, numeric value, date, currency symbol, etc.) of data in each column in the headed table, so as to obtain a data type identification result corresponding to the headed table. The processor 11 may utilize, for example, pattern recognition, regular expression, or rule matching to identify the data type of each column. The data type identification result is obtained by combining the data type of each column into one result. For example, the data type identification result may indicate that the data types respectively of the columns are date, text only, and numeric value.

In step S17, for each column of each headed table, the processor 11 standardizes data in the column and removes parts of the data that do not conform with a predetermined type (i.e., the data type identified in step S16). For example, dates in formats of YYYY-MM-DD and MM/DD/YYYY may be standardized into the same format; and if the predetermined type of the column is numeric value, text data and a null value in the column, which do not conform with the predetermined type, may be removed.

In step S18, the processor 11 groups the headed tables to obtain at least one table group based on the set of headers of each one of the headed tables, a number of columns of each one of the headed tables, and the data type identification results respectively of the headed tables. Each table group includes at least one of the headed tables all having the same set of headers, the same number of columns and the same data type identification result.

In step S19, for each table group that includes multiple headed tables, the processor 11 merges the headed tables in the table group sequentially based on the table numbers respectively of the headed tables in the table group, so as to obtain a merged table. It should be noted that in a case where the table group includes only one headed table, merging is not performed, and the headed table serves as the merged table. It should also be noted that only the set of headers of the headed table having a smallest table number among the headed tables in the table group is retained during merging of the headed tables. For remaining headed table(s) in the table group (i.e., the headed table(s) in the table group except the headed table having the smallest table number), the data area of each remaining headed table is merged to the end of the data area of a previous headed table in sequence based on the table number(s) respectively of the remaining headed table(s) and the starting row number of the data area of each remaining headed table. The previous headed table is one of the headed tables in the table group that has the table number sequentially before and closest to the table number of the remaining headed table to be merged. For example, if one table group contains the headed table having the table number of 1 (Table 1) and having twenty rows, the headed table having the table number of 2 (Table 2), having ten rows, and having the starting row number of the data area of row 2, and the headed table having the table number of 3 (Table 3), having ten rows, and having the starting row number of the data area of row 2, only the set of headers of Table 1 will be retained during merging; the data area (i.e., the rows starting from row 2) of Table 2 will be merged to the end of the data area of Table 1 (i.e., after row 20 of Table 1); and the data area (i.e., the rows starting from row 2) of Table 3 will be merged to the end of the data area of Table 2 (i.e., after row 10 of Table 2).

In summary, by categorizing each of the tables contained in the file in PDF format as a headed table or a headerless table, and generating the set of headers for each headerless table, each one of the tables in the file end up as one of the headed tables, which assists in identifying the data in each column of each one of the headed tables, thereby facilitating subsequent grouping and merging of the headed tables. Furthermore, by grouping the headed tables based on the set of headers of each one of the headed tables, the number of columns of each one of the headed tables, and the data type identification results respectively of the headed tables, and merging the headed tables in each table group separately, different types of tables may be merged separately to overcome the difficulty of merging a diversity of tables contained in the file. In addition, automatically extracting, categorizing and merging the tables in the file may effectively reduce the burden on data analysis personnel when processing multi-page tables in PDF files, and facilitate rapid access to data in the tables for subsequent analysis. Therefore, the object of the disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for document processing of tables contained in a file in Portable Document Format (PDF), the method comprising steps of:
obtaining tables contained in the file and assigning table numbers respectively to the tables;
for each one of the tables, categorizing the table into one of a type of table with headers and a type of table without headers, wherein each one of the tables having a set of headers is categorized into the type of table with headers;
for each one of the tables that is categorized into the type of table without headers, generating a set of headers for the table that is categorized into the type of table without headers so as to make the table become the type of table with headers;
after the step of generating a set of headers for the table that is categorized into the type of table without headers, for each one of the tables, identifying a data type for data in each column in the table, so as to obtain a data type identification result corresponding to the table;
based on the set of headers of each one of the tables, a number of columns of each one of the tables, and the data type identification results respectively of the tables, grouping the tables to obtain at least one table group, each one of the at least one table group including at least one of the tables all having the same set of headers, the same number of columns and the same data type identification result; and
for each one of the at least one table group, merging the tables in the table group sequentially based on the table numbers respectively of the tables in the table group, so as to obtain a merged table.

2. The method as claimed in claim 1, the file having a plurality of pages, wherein the step of obtaining the tables contained in the file and assigning the table numbers respectively to the tables includes, for each page of the plurality of pages:
analyzing the page to obtain a text analysis result that relates to text content, text spacing and text alignment on the page, and to obtain a line analysis result that relates to visible lines on the page; and
based on the text analysis result and the line analysis result, obtaining at least one table contained in the page and assigning at least one table number respectively to the at least one table.

3. The method as claimed in claim 1, wherein the step of categorizing each one of the tables into one of a type of table with headers and a type of table without headers includes identifying a header area and a data area of the table based on format characteristics of each cell of the table, so as to categorize the table into one of the type of table with headers and the type of table without headers.

4. The method as claimed in claim 3, wherein the format characteristics of each cell of the table include at least a font size, a font style, a typeface style and a data type.

5. The method as claimed in claim 1, further comprising a step of, after the step of categorizing each one of the tables into one of a type of table with headers and a type of table without headers:
for each one of the tables that is categorized into the type of table with headers, standardizing the set of headers of the table.

6. The method as claimed in claim 5, wherein standardizing the set of headers includes string matching, space removal and case unification.

7. The method as claimed in claim 1, wherein the step of generating the set of headers for the table that is categorized into the type of table without headers includes:
obtaining a basis table that is one of the tables categorized into the type of table with headers and that has the table number sequentially before and closest to the table number of the table categorized into the type of table without headers;
determining whether the table categorized into the type of table without headers is consistent with the basis table based on a number of columns of the basis table, format characteristics of a data area of the basis table, a number of columns of the table categorized into the type of table without headers, and format characteristics of a data area of the table categorized into the type of table without headers;
in response to determining that the table categorized into the type of table without headers is consistent with the basis table, making the set of headers of the basis table serve as the set of headers of the table categorized into the type of table without headers; and
in response to determining that the table categorized into the type of table without headers is not consistent with the basis table, making a predetermined set of headers serve as the set of headers of the table categorized into the type of table without headers.

8. The method as claimed in claim 1, further comprising a step of, after the step of identifying the data type and prior to the step of grouping the tables with headers to obtain at least one table group:
for each column of each one of the tables, standardizing data in the column of the table and removing parts of the data that do not conform with a predetermined type.

9. The method as claimed in claim 8, wherein standardizing data in the column of the table is to unify formats of the data in the column of the table into the same format.
